(19) United States
(12) Patent Application Publication
(10) Pub. No.: US 2013/0154609 A1
(43) Pub. Date: Jun. 20, 2013

(54) APPARATUS AND METHOD FOR RECODING NEURAL SIGNALS

(71) Applicants: Sang Don JUNG, Daejeon (KR); Young Hee KIM, Daejeon (KR); Nam Seob BAEK, Daejeon (KR)

(72) Inventors: Sang Don JUNG, Daejeon (KR); Young Hee KIM, Daejeon (KR); Nam Seob BAEK, Daejeon (KR)

(73) Assignee: Electronics and Telecommunications Research Institute, Daejeon (KR)

(21) Appl. No.: 13/615,171

(22) Filed: Sep. 13, 2012

(30) Foreign Application Priority Data
Dec. 19, 2011 (KR) 10-2011-0137368

(51) Int. Cl. G01N 27/00

(52) U.S. Cl. 324/71.1

(57) ABSTRACT

Provided are an apparatus and a method for recoding neuronal signals. The apparatus may include a substrate with an electrode region, a plurality of stimulation electrodes arranged on the electrode region to have a specific arrangement, and at least one recording electrode provided between adjacent ones of the stimulation electrodes and attached with an axon of the neuronal cell. Each of the stimulation electrodes may be attached with a body of a neuronal cell.

### CROSS-REFERENCE TO RELATED APPLICATIONS

This U.S. non-provisional patent application claims priority under 35 U.S.C. §119 to Korean Patent Application No. 10-2011-0137368, filed on Dec. 19, 2011, in the Korean

Intellectual Property Office, the entire contents of which are hereby incorporated by reference.

### BACKGROUND OF THE INVENTION

Embodiments of the inventive concepts relate to an apparatus and a method for recoding neuronal signals, and in particular, a neuronal-signal recording apparatus configured to reduce interference between neuronal signals of neuronal cells and a neuronal-signal recording method using the same.

In vivo or in vitro neuronal interface aims to record signals from neuronal cells. In the neuronal interface field, research is being carried out to obtain a material that can be used for a nerve electrode allowing a stable growth of the neuronal cell. In addition, there have been researches to develop a nerve electrode array capable of improving resolution in measuring the signals from the neuronal cells.

The neuronal cell may include a dendrite, an axon, and a synapse. If a chemical stimulation signal is detected by the dendrite, the chemical stimulation signal is converted into an electrical signal by the axon, and the electrical signal is converted into a neurotransmitter at the synapse. The neurotransmitter may serve as a chemical stimulation signal to be detected by a dendrite of other neuronal cell adjacent thereto. A neuronal cell chip may be configured to analyze electrical signals of neuronal cells using multi-channel micro electrodes. Furthermore, the neuronal cell chip may be configured to grow a neuronal cell at a specific region in a form of network and then perform an electrical stimulation on and a recoding of the grown neuronal cell.

### SUMMARY

Embodiments of the inventive concepts provide a neuronal-signal recording apparatus configured to reduce interference between neuronal signals of neuronal cells.

Other embodiments of the inventive concepts provide a neuronal-signal recording method configured to reduce interference between neuronal signals of neuronal cells.

According to example embodiments of the inventive concepts, a neuronal-signal recording apparatus may include a substrate with an electrode region, a plurality of stimulation electrodes arranged on the electrode region to have a specific arrangement, each of the stimulation electrodes being attached with a body of a neuronal cell, and at least one recording electrode provided between adjacent ones of the stimulation electrodes and attached with an axon of the neuronal cell.

In example embodiments, the apparatus may further include a micro pattern provided on the electrode region. The micro pattern may include a groove-shaped channel crossing and exposing the stimulation electrodes and the recording electrode therebetween. The channel may serve as a pathway, through which the neuronal cell may be grown from the stimulation electrode to the recording electrode.

In example embodiments, the stimulation electrode may be used to apply an electrical stimulation to the body of the neuronal cell. The stimulation electrode may be used to record a neuronal signal in the body of the neuronal cell caused by the electrical stimulation. The recording electrode may be used to record a neuronal signal in the axon of the neuronal cell, which may be caused by the electrical stimulation applied to the body of the neuronal cell.

In example embodiments, the apparatus may further include at least one interconnection wire and at least one pad, which may be connected to the stimulation electrodes and the recording electrode therebetween. The pad may be provided on an outer region of the substrate outside the electrode region, and the interconnection wire may be provided to connect the stimulation and recording electrodes electrically with the pad.

According to example embodiments of the inventive concepts, a method of recording a neuronal signal may include applying an electrical stimulation to a body of a neuronal cell through a stimulation electrode attached with the body of the neuronal cell, and then, recording a neuronal signal in an axon of the neuronal cell, which may be caused by the electrical stimulation applied to the body of the neuronal cell, using a recording electrode attached with the axon of the neuronal cell.

In example embodiments, the method may further include using the stimulation electrode to record a neuronal signal in the body of the neuronal cell caused by the electrical stimulation.

In example embodiments, the axon of the neuronal cell may be grown from the body of the neuronal cell attached to the stimulation electrode and be then attached to the recording electrode.

### BRIEF DESCRIPTION OF THE DRAWINGS

Example embodiments will be more clearly understood from the following brief description taken in conjunction with the accompanying drawings. FIGS. 1 and 2 represent non-limiting, example embodiments as described herein.

FIG. 1 is a schematic perspective view illustrating a neuronal-signal recording apparatus according to example embodiments of the inventive concept; and

FIG. 2 is a flow chart illustrating a neuronal-signal recording method, in which the neuronal-signal recording apparatus according to example embodiments of the inventive concept is used.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown.

Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

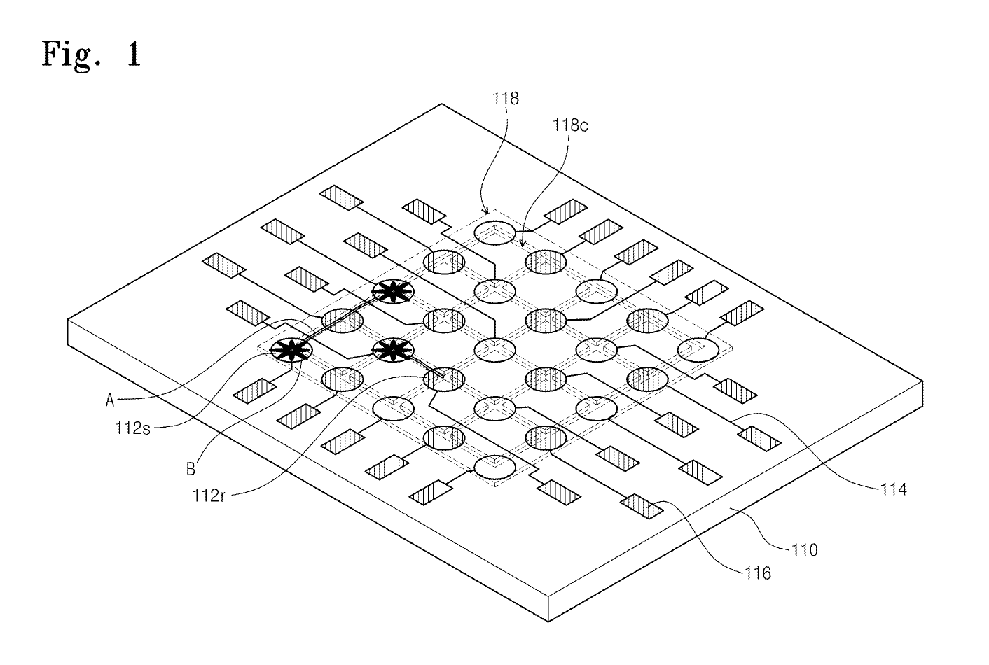

FIG. 1 is a schematic perspective view illustrating a neuronal-signal recording apparatus according to example embodiments of the inventive concept.

Referring to FIG. 1, a neuronal-signal recording apparatus may include an electrode array provided on an electrode region of a substrate 110 to have a specific arrangement. The electrode array may include a plurality of stimulation electrodes 112s, each of which may be attached with a body B of a neuronal cell and at least one recording electrode 112r attached with an axon A of a neuronal cell. The axon A of the neuronal cell may be singly attached to the recording electrode 112r. The recording electrode 112r may be provided between adjacent ones of the stimulation electrodes 112s. Surfaces of the stimulation electrodes 112s and the recording electrode 112r may be modified in such a way that the single axon A can be attached thereon.

The neuronal-signal recording apparatus may further include a micro pattern 118 provided on the electrode region of the substrate 110. The micro pattern 118 may be formed to have a groove-shaped channel 118c crossing and exposing the stimulation electrodes 112s and the recording electrode 112r therebetween. The axon A of the neuronal cell may be grown from the body B of the neuronal cell attached to the stimulation electrode 112s and be attached to the recording electrode 112r. In other words, the channel 118c may serve as a pathway allowing the growth of the body B from the stimulation electrode 112s toward the recording electrode 112r or as a pathway through which the growth of the neuronal cell may occur. In example embodiments, various patterning methods may be used to form the micro pattern 118 with the channel 118c.

The stimulation electrode 112s may be used to apply an electrical stimulation to the body B of the neuronal cell. The stimulation electrode 112s may be used to record a neuronal signal in the body B of the neuronal cell caused by the electrical stimulation. The recording electrode 112r may be used to record a neuronal signal in the axon A of the neuronal cell, which may be caused by the electrical stimulation applied to the body B of the neuronal cell.

The neuronal-signal recording apparatus may further include at least one interconnection wire 114 and at least one pad 116, which may be connected to the stimulation electrodes 112s and the recording electrode 112r therebetween. In example embodiments, the pad 116 may be provided on an outer region of the substrate 110 outside the electrode region, and the interconnection wire 114 may connect the stimulation electrodes 112s and the recording electrode 112r with the pad 116. At least one of the stimulation electrodes 112s, the recording electrode 112r, the interconnection wire 114, and the pad 116 may include a gold-containing layer.

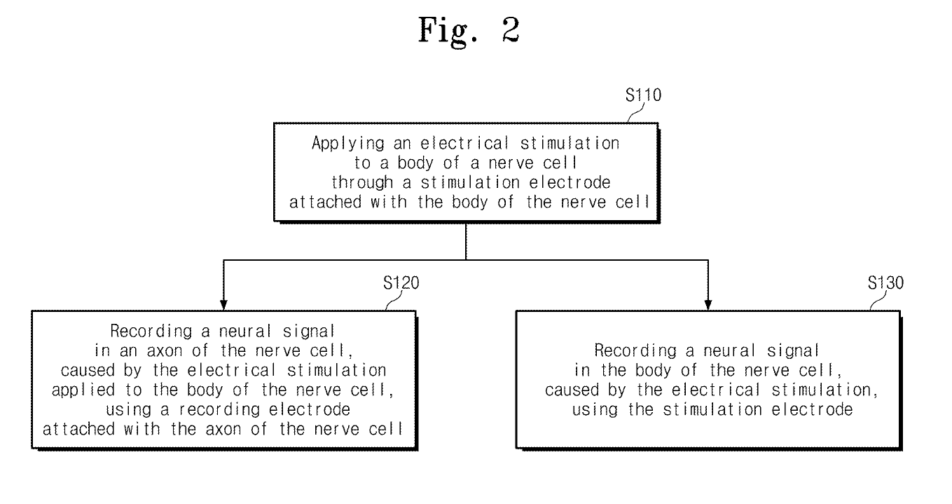

FIG. 2 is a flow chart illustrating a neuronal-signal recording method, in which the neuronal-signal recording apparatus according to example embodiments of the inventive concept is used.

Referring to FIG. 2, a neuronal-signal recording method using the neuronal-signal recording apparatus may include applying an electrical stimulation to the body B of the neuronal cell through the stimulation electrode 112s attached with the body B of the neuronal cell (in S110) and recording a neuronal signal in the axon A of the neuronal cell, which may be caused by the electrical stimulation applied to the body B of the neuronal cell, using the recording electrode 112r attached with the axon A of the neuronal cell (in S120). The neuronal-signal recording method may further include recording a neuronal signal in the body B of the neuronal cell, caused by the electrical stimulation, using the stimulation electrode 112s (in S130).

According to example embodiments of the inventive concept, the neuronal-signal recording apparatus may be configured to have the electrode array including the stimulation electrode and the recording electrode separated from each other. As the result of the separation between the electrodes, it is possible to reduce interference, overlapping, or disturbance between neuronal signals, during an operation of recording the neuronal signals, and the neuronal signals can be recorded with stability. Accordingly, it is possible to provide a neuronal-signal recording apparatus with improved resolution in measuring neuronal signals and a neuronal-signal recording method using the same.

While example embodiments of the inventive concepts have been particularly shown and described, it will be understood by one of ordinary skill in the art that variations in form and detail may be made therein without departing from the spirit and scope of the attached claims.

What is claimed is:

1. A neuronal-signal recording apparatus, comprising:
a substrate with an electrode region;
a plurality of stimulation electrodes arranged on the electrode region to have a specific arrangement, each of the stimulation electrodes being attached with a body of a neuronal cell; and
at least one recording electrode provided between adjacent ones of the stimulation electrodes and attached with an axon of the neuronal cell.

2. The apparatus of claim 1, further comprising:
a micro pattern provided on the electrode region,
wherein the micro pattern includes a groove-shaped channel crossing and exposing the stimulation electrodes and the recording electrode therebetween.

3. The apparatus of claim 2, wherein the channel serves as a pathway, through which the neuronal cell is grown from the stimulation electrode to the recording electrode.

4. The apparatus of claim 1, wherein the stimulation electrode is used to apply an electrical stimulation to the body of the neuronal cell.

5. The apparatus of claim 4, wherein the stimulation electrode is used to record a neuronal signal in the body of the neuronal cell caused by the electrical stimulation.

6. The apparatus of claim 4, wherein the recording electrode is used to record a neuronal signal in the axon of the neuronal cell, which is caused by the electrical stimulation applied to the body of the neuronal cell.

7. The apparatus of claim 1, further comprising:
at least one interconnection wire and at least one pad, which are connected to the stimulation electrodes and the recording electrode therebetween,
wherein the pad is provided on an outer region of the substrate outside the electrode region, and
wherein the interconnection wire is provided to connect the stimulation and recording electrodes electrically with the pad.

8. A method of recording a neuronal signal, comprising:
applying an electrical stimulation to a body of a neuronal cell through a stimulation electrode attached with the body of the neuronal cell; and
recording a neuronal signal in an axon of the neuronal cell, which is caused by the electrical stimulation applied to the body of the neuronal cell, using a recording electrode attached with the axon of the neuronal cell.

9. The method of claim 8, further comprising:
using the stimulation electrode to record a neuronal signal in the body of the neuronal cell caused by the electrical stimulation.

10. The method of claim 8, wherein the axon of the neuronal cell is grown from the body of the neuronal cell attached to the stimulation electrode and is then attached to the recording electrode.
